(19) United States
(12) Patent Application Publication
(10) Pub. No.: US 2015/0049079 A1
(43) Pub. Date: Feb. 19, 2015

(54) TECHNIQUES FOR THREEDIMENSIONAL IMAGE EDITING

(71) Applicant: INTEL CORPORATION, Santa Clara, CA (US)

(72) Inventors: Dayong Ding, Beijing (CN); Yangzhou Du, Beijing (CN); Jianguo Li, Beijing (CN)

(21) Appl. No.: 13/977,075

(22) PCT Filed: Mar. 13, 2013
(86) PCT No.: PCT/CN2013/072544

§ 371 Date: Jun. 28, 2013

(51) Int. Cl. G06T 11/60; G06T 15/00

(52) U.S. Cl. CPC G06T 11/60; G06T 15/00
USPC 345/419

(57) ABSTRACT

Techniques for three-dimensional (3D) image editing are described. In one embodiment, for example, an apparatus may comprise a processor circuit and a 3D graphics management module, and the 3D graphics management module may be operable by the processor circuit to determine modification information for a first sub-image in a 3D image comprising the first sub-image and a second sub-image, modify the first sub-image based on the modification information for the first sub-image, determine modification information for the second sub-image based on the modification information for the first sub-image, and modify the second sub-image based on the modification information for the second sub-image. Other embodiments are described and claimed.

### TECHNICAL FIELD

Embodiments described herein generally relate to the generation, manipulation, presentation, and consumption of three-dimensional (3D) images.

### BACKGROUND

Various conventional techniques exist for the generation of 3D images. According to some such techniques, a particular 3D image may be comprised of multiple sub-images. For example, 3D images generated ac cording to stereoscopic 3D technology are comprised of left and right sub-images that create 3D effects when viewed in tandem. In order to edit such a 3D image, it may be necessary to perform modifications of its sub-images. The modifications should be determined such that the quality of the 3D image is preserved.

### BRIEF DESCRIPTION OF THE DRAWINGS

FIG. 1 illustrates one embodiment of an apparatus and one embodiment of a first system.

FIG. 2 illustrates one embodiment of a series of sub-image modifications.

FIG. 3 illustrates one embodiment of a logic flow.

FIG. 4 illustrates one embodiment of a second system.

FIG. 5 illustrates one embodiment of a third system.

FIG. 6 illustrates one embodiment of a device.

### DETAILED DESCRIPTION

Various embodiments may be generally directed to techniques for three-dimensional (3D) image editing. In one embodiment, for example, an apparatus may comprise a processor circuit and a 3D graphics management module, and the 3D graphics management module may be operable by the processor circuit to determine modification information for a first sub-image in a 3D image comprising the first sub-image and a second sub-image, modify the first sub-image based on the modification information for the first sub-image, determine modification information for the second sub-image based on the modification information for the first sub-image, and modify the second sub-image based on the modification information for the second sub-image. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

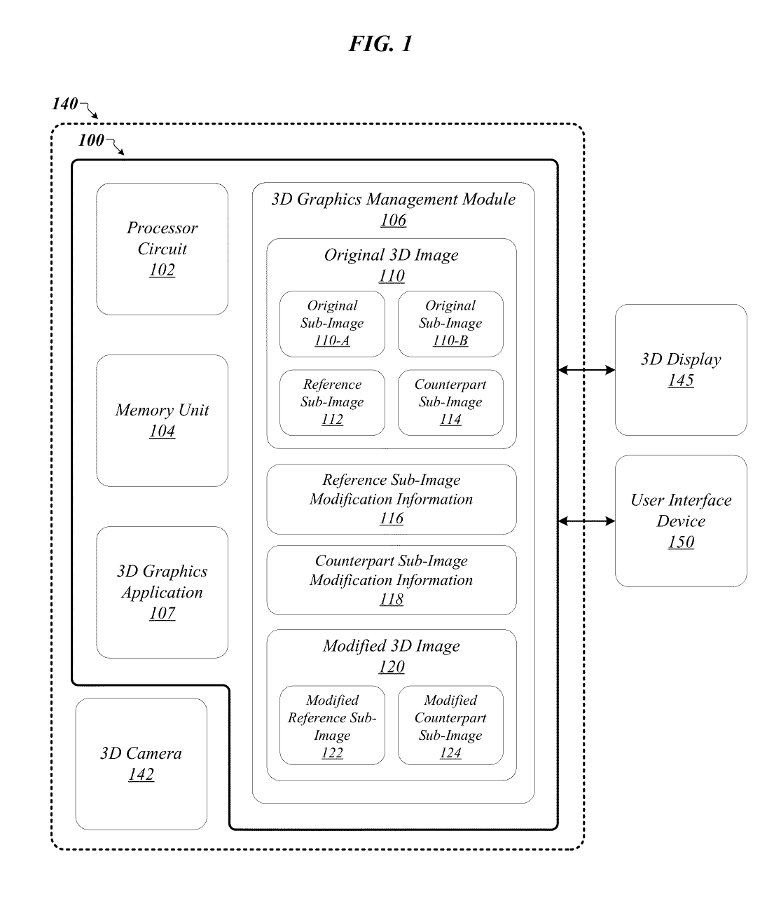

FIG. 1 illustrates a block diagram of an apparatus 100. As shown in FIG. 1, apparatus 100 comprises multiple elements including a processor circuit 102, a memory unit 104, and a 3D graphics management module 106. The embodiments, however, are not limited to the type, number, or arrangement of elements shown in this figure.

In various embodiments, apparatus 100 may comprise processor circuit 102. Processor circuit 102 may be implemented using any processor or logic device, such as a complex instruction set computer (CISC) microprocessor, a reduced instruction set computing (RISC) microprocessor, a very long instruction word (VLIW) microprocessor, an x86 instruction se compatible processor, a processor implementing a combination of instruction sets, a multi-core processor such as a dual-core processor or dual-core mobile processor, or any other microprocessor or central processing unit (CPU). Processor circuit 102 may also be implemented as a dedicated processor, such as a controller, a microcontroller, an embedded processor, a chip multiprocessor (CMP), a co-processor, a digital signal processor (DSP), a network processor, a media processor, an input/output (I/O) processor, a media access control (MAC) processor, a radio baseband processor an application specific integrated circuit (ASIC), a field programmable gate array (FPGA), a programmable logic device (PLD), and so forth. In one embodiment, for example, processor circuit 102 may be implemented as a general impose processor, such as a processor made by Intel® Corporation, Santa Clara, Calif. The embodiments are not limited in this context.

In some embodiments, apparatus 100 may comprise or be arranged to communicatively couple with a memory unit 104. Memory unit 104 may be implemented using any machine-readable or computer-readable media capable of storing data, including both volatile and non-volatile memory. For example, memory unit 104 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory; phase change or ferroelectric memory, silicon-oxide-nitride-oxide-silicon (SONOS) memory, magnetic or optical cards, or any other type of media suitable for storing information. It is worthy of note that some portion or all of memory unit 104 may be included on the same integrated circuit as processor circuit 102, or alternatively some portion or all of memory unit 104 may be disposed on an integrated circuit or other medium, for example a hard disk drive, that is external to the integrated circuit of processor circuit 102. Although memory unit 104 is comprised within apparatus 100 in FIG. 1, memory unit 104 may be external to apparatus 100 in some embodiments. The embodiments are not limited in this context.

In various embodiments, apparatus 100 may comprise a 3D graphics management module 106. 3D graphics management module 106 may comprise logic and/or circuitry operative to generate, process, analyze, modify and/or transmit one or more 3D images or sub-images. In some embodiments, processor circuit 102 may be operative to execute a 3D graphics application 107, and 3D graphics management module 106 may be operative to perform one or more operations based on information, logic, data, and/or instructions received from 3D graphics application 107. 3D graphics application 107 may comprise any application featuring 3D image capture, generation, processing, analysis, and/or editing capabilities. In various embodiments, for example, 3D graphics application 107 may comprise a 3D image processing and editing application. The embodiments are not limited to this example.

FIG. 1 also illustrates a block diagram of a system 140. System 140 may comprise any of the aforementioned elements of apparatus 100. System 140 may further comprise a 3D camera 142. 3D camera 142 may comprise any device capable of capturing 3D images. For example, in some embodiments, 3D camera 142 may comprise a dual-lens stereoscopic camera. In various other embodiments, 3D camera 142 may comprise a camera array featuring more than two lenses. The embodiments are not limited in this context.

In some embodiments, apparatus 100 and/or system 140 may be configurable to communicatively couple with a 3D display 145. 3D display 145 may comprise any 3D display device capable of displaying information received from apparatus 100 and/or system 140. Examples for 3D display 145 may include a 3D television, a 3D monitor, a 3D projector, and a 3D computer screen. In one embodiment, for example, 3D display 145 may be implemented by a liquid crystal display (LCD) display, light emitting diode (LED) display, or other type of suitable visual interface featuring 3D capabilities. 3D display 145 may comprise, for example, a touch-sensitive color display screen. In various implementations, 3D display 145 may comprise one or more thin-film transistors (TFT) LCDs including embedded transistors. In some embodiments, 3D display 145 may comprise a stereoscopic 3D display. In various other embodiments, 3D display 145 may comprise a holographic display or another type of display capable of creating 3D visual effects. In various embodiments, 3D display 145 may be arranged to display a graphical user interface operable to directly or indirectly control 3D graphics application 107. For example, in some embodiment; 3D display 145 may be arranged to display a graphical user interface generated by 3D graphics application 107. In such embodiments, the graphical user interface may enable operation of 3D graphics application 107 to capture, generate, process, analyze, and/or edit one or more 3D images. The embodiments are not limited in this context.

In some embodiments, apparatus 100 and/or system 140 may be configurable to communicatively couple with a user interface device 150. User interface device 150 may comprise any device capable of accepting user input for processing by apparatus 100 and/or system 140. In some embodiments, user interface device 150 may be operative to receive one or more user inputs and to transmit information describing those inputs to apparatus 100 and/or system 140. In various embodiments, one or more operations of apparatus 100 and/or system 140 may be controlled based on such user inputs. For example, in some embodiments, user interface device 150 may receive user input comprising a request to edit a 3D image using 3D graphics application 107, and/or comprising a selection of one or more editing capabilities of 3D graphics application 107 for performance on the 3D image and/or on a sub-image thereof. Examples of user interface device in some embodiments may include a keyboard, a mouse, a track ball, a stylus, a joystick, and a remote control. In various embodiments, user interface device 150 may comprise user input components and/or capabilities of 3D display 145 in addition to and/or in lieu of comprising a stand-alone device. For example, in some embodiments, user interface device 150 may comprise touch-screen capabilities of 3D display 145, using which user input may be received via motions of the user's fingers on a screen of 3D display 145. In various embodiments, apparatus 100 and/or system 140 may be capable of accepting user input directly, and may itself comprise user input device 150. For example, in some embodiments, apparatus 100 and/or system 140 may comprise voice recognition capabilities and may accept user input in the form of spoken commands and/or sounds. The embodiments are not limited in this context.

In general operation, apparatus 100 and/or system 140 may be operative to cause one or more 3D images to be presented on 3D display 145. In various embodiments, such 3D images may comprise stereoscopic 3D images comprising left and right sub-images corresponding to visual effects intended to be incident upon the respective left and right eyes of a viewer of 3D display 145. In some embodiments, apparatus 100 and/or system 140 may enable the editing of such 3D images. For example, in various embodiments, apparatus 100 and/or system 140 may enable a viewer of a 3D image to use 3D graphics application 107 to edit the 3D image by entering input via user interface device 150. The embodiments are not limited in this context.

In some embodiments, 3D graphics management module 106 may be operative to receive an original 3D image 110 comprising an original sub-image 110-A and an original sub-image 110-B. In various embodiments, original sub-images 110-A and 110-B may comprise images that, when simultaneously displayed by 3D display 145, create one or more 3D effects associated with original 3D image 110. In some embodiments, original 3D image 110 may comprise a stereoscopic 3D image, and original images 110-A and 110-B may comprise left and right sub-images therein. In various embodiments, 3D camera 142 may be operative to capture original 3D image 110 and transmit it to apparatus 100 and/or system 140. In some embodiments, 3D camera 142 may comprise a dual-lens stereoscopic 3D camera, and original sub-images 110-A and 110-B may comprise images captured by respective left and right lenses of 3D camera 142. The embodiments are not limited in this context.

In various embodiments, 3D graphics management module 106 may be operative to select one of original sub-images 110-A and 110-B for editing by a user. This selected sub-image may be referred to as a reference sub-image 112, and the non-selected sub-image may be referred to as a counterpart sub-image 114. For example, in an embodiment in which 3D graphics management module 106 selects original sub-image 110-B for editing, reference sub-image 112 may comprise original sub-image 110-B and counterpart sub-image 114 may comprise original sub-image 110-A. In some embodiments, 3D graphics management module 106 may perform the selection of reference sub-image 112 based on user input received via user input device 150, while in other embodiments 3D graphics management module 106 may perform this selection arbitrarily or based on predefined settings. 3D graphics management module 106 may then be operative on 3D display 145 to present reference sub-image 112 for editing, viewing, manipulation, and/or processing. For example, in one embodiment, a predefined setting may stipulate that the left sub-image of an original 3D image 110 comprising a stereoscopic 3D image is to be selected as reference sub-image 112. Based on this predefined setting, 3D graphics management module 106 may be operative on 3D display 145 to present that left sub-image for editing, viewing, manipulation, and/or processing. The embodiments are not limited to this example.

In various embodiments, 3D graphics management module 106 may be operative to determine reference sub-image modification information 116. Reference sub-image modification information 116 may comprise logic, data, information, and/or instructions indicating one or more modifications to be made to reference sub-image 112. For example, in some embodiments, reference sub-image modification information 116 may indicate one or more elements to be added to, removed from, relocated within, or changed within reference sub-image 112. In these and/or additional example embodiments, reference sub-image modification information 116 may indicate one or more alterations to be made to visual properties of reference sub-image 112, such as brightness, contrast, saturation, hue, color balance, and/or other visual properties. In these and/or further example embodiments, reference sub-image modification information 116 may indicate one or more geometric transformations to be performed on reference sub-image 112, such as cropping, rotation, reflection, stretch, skew, and/or other transformations. Additional types of modifications are both possible and contemplated, and the embodiments are not limited in this context.

In various embodiments, 3D graphics management module 106 may be operative to determine reference sub-image modification information 116 based on user input received via user interface device 150. In some embodiments, such user input may be received in conjunction with operation of 3D graphics application 107. In an example embodiment, a user of 3D graphics application 107 may indicate a desire to edit original 3D image 110, and reference sub-image 112 may be presented on 3D display 145. The user may then utilize user interface device 150 to enter user input understood by 3D graphics application 107 as an instruction to rotate reference sub-image 112 clockwise by 15 degrees. Based on this instruction, 3D graphics management module 106 may then determine reference sub-image modification information 116 indicating that reference sub-image 112 is to be rotated clockwise by 15 degrees. In various embodiments, once it has determined reference sub-image modification information 116, 3D graphics management module 106 may be operative to generate modified reference sub-image 122 by modifying reference sub-image 112 based on reference sub-image modification information 116. The embodiments are not limited in this context.

In some embodiments, 3D graphics management module 106 may be operative to determine counterpart sub-image modification information 118 based on reference sub-image modification information 116. Counterpart sub-image modification information 118 may comprise logic, data, information, and/or instructions indicating one or more modifications to be made to counterpart sub-image 114 in order to generate a modified counterpart sub-image 124 that is synchronized with modified reference sub-image 122. As employed herein in reference to modified reference sub-image 122 and modified counterpart sub-image 124, the term “synchronized” is defined to denote that the modifications of the two sub-images are consistent with each other such that a modified 3D image 120 generated based on the two modified sub-images will appropriately reflect the desired modifications indicated by the received user input. For example, in an example embodiment in which a user inputs an instruction to rotate reference sub-image 112 clockwise by 15 degrees, modified counterpart sub-image 124 is synchronized with modified reference sub-image 122 if a modified 3D image 120 generated based on these two sub-images exhibits a clockwise rotation of 15 degrees with respect to original 3D image 110. The embodiments are not limited in this context.

In various embodiments, generating a modified counterpart sub-image 124 that is synchronized with modified reference sub-image 122 may not be as straightforward as applying the exact same modifications to the same regions and/or elements of counterpart sub-image 114 as were applied to reference sub-image 112 according to reference sub-image modification information 116. Because reference sub-image 112 and counterpart sub-image 114 may be captured by different lenses, sensors, cameras, and/or image capture devices, any particular pixel in reference sub-image 112 may rot necessarily correspond to the same pixel in counterpart sub-image 114. Corresponding pixels in the two sub-images may exhibit horizontal and/or vertical displacements with respect to each other, and may be associated with differing depths and/or orientations with respect to the optical centers of the lenses, sensors, cameras, and/or image capture devices that captured them. Depending on the nature of reference sub-image modification information 116, various techniques may be employed in order to determine counterpart sub-image modification information 118 that will result in a modified counterpart sub-image 124 that is synchronized with modified reference sub-image 122.

In some embodiments, reference sub-image modification information 116 may indicate a cropping of reference sub-image 112. Such a cropping may comprise a selection of a region within reference sub-image 112 that is to comprise modified reference sub-image 122, with portions of reference sub-image 112 falling outside that region being discarded. In order to determine counterpart sub-image modification information 118 that will result in a modified counterpart sub-image 124 that is synchronized with the cropped reference sub-image 112, 3D graphics management module 106 may be operative to use pixel-matching techniques to determine a region within counterpart sub-image 114 that corresponds to the selected region within reference sub-image 112. However, if the respective selected regions within reference sub-image 112 and counterpart sub-image 114 are not centered within those sub-images, they may comprise optical centers that differ from those of the unmodified sub-images. In essence, under such circumstances, the optical axes of the cropped sub-images will not be perpendicular to their image planes. If compensation is not performed for this effect, the cropped sub-images may exhibit vertical parallax. Vertical parallax denotes a circumstance in which corresponding pixels of two sub-images within a 3D image do not share common pixel rows. Vertical parallax may result in blurring and diminished quality of 3D effects in such a 3D image, and may also lead to symptoms of discomfort for viewers of such a 3D image, such as headaches, vertigo, nausea, and/or other undesirable symptoms.

In order to minimize or eliminate vertical parallax, 3D graphics management module 106 may be operative to perform image rectification in conjunction with crowing reference sub-image 112 and cropped counterpart sub-image 114 in various embodiments. In some embodiments, this may comprise determining reference sub-image modification information 116 and counterpart sub-image modification information 118 such that when they are used to modify reference sub-image 112 and counterpart sub-image 114 respectively, a modified reference sub-image 122 and a modified counterpart sub-image 124 are obtained that are properly cropped and rectified. Such image rectification may be performed according to one or more conventional techniques for rectification of stereo 3D images. The embodiments are not limited in this context. In various embodiments, reference sub-image modification information 116 may indicate a rotation of reference sub-image 112. Such a rotation may comprise rotating the pixels of reference sub-image 112 either clockwise or counter-clockwise around a particular point within reference sub-image 112, such as its optical center. 3D graphics management module 106 may then be operative to determine counterpart sub-image modification information 118 that indicates an equivalent rotation of the pixels of counterpart sub-image 114. This may comprise using pixel-matching techniques to determine a corresponding point in counterpart sub-image 114 that matches the point in reference sub-image 112 around which the first rotation was performed, and rotating the pixels of counterpart sub-image 114 around that corresponding point. However, an equivalent rotation of the pixels of counterpart sub-image 114 may not necessarily be of the same number of degrees as that of the pixels of reference sub-image 112, due to the difference in orientation of the two image planes. Thus, simply performing the same rotation in counterpart sub-image 114 as was perforate din reference sub-image 112 may result in vertical parallax.

As such in some embodiments, 3D graphics management module 106 may be operative to utilize pixel-matching techniques to identify a region within counterpart sub-image 114 that corresponds to that contained within rotated reference sub-image 112. In such embodiments, 3D graphics management module 106 may then be operative to determine a rotation for counterpart sub-image 114 that is equivalent to that perforated for reference sub-image 112. 3D graphics management module 106 may also be operative to crop rotated reference sub-image 112 and rotated counterpart sub-image 114 such that portions of each that have no corresponding portion in the other are discarded. In various embodiments, 3D graphics management module 106 may be operative to perform image rectification in conjunction with rotating and cropping counterpart sub-image 114, to minimize or eliminate vertical parallax in the combination of modified reference sub-image 122 and modified counterpart sub-image 124. The embodiments are not limited in this context.

In some embodiments, reference sub-image modification information 116 may indicate an insertion of text, labels, figures, diagrams, images, icons, and/or one or more other elements into reference sub-image 112. Such insertions are here after generically referred to as “annotations,” but it is to be understood that as referenced herein, an annotation may comprise any type of inserted visual element, and may not necessarily comprise explanatory text or even text at all. In various embodiments, reference sub-image modification information 116 that indicates an annotation of reference sub-image 112 may identify a visual element to be incorporated into reference sub-image 112 and a desired position of that element within modified reference sub-image 122. In some embodiments, the intent of an annotation may be to explain illustrate, supplement highlight and/or emphasize a feature within original 3D image 110, and thus the annotation may be inserted into reference sub-image 112 in a position that is adjacent to elements corresponding to that feature in original 3D image 110. In various embodiments, the feature of interest in original 3D image 110 may exhibit a particular apparent depth, and it may be desirable to generate modified 3D image 120 such that the annotation appears not only in a position adjacent to the feature, but also with a same or similar apparent depth as the feature.

In some embodiments, 3D graphics management module 106 may be operative to determine a feature of interest in original 3D image 110 based on the position of insertion of an annotation into reference sub-image 112. In various embodiments, 3D graphics management module 106 may be operative to perform such a determination using one or more conventional feature recognition techniques. For example, 3D graphics management module 106 may be operative to utilize feature recognition techniques to recognize a face next to which an annotation has been inserted in reference sub-image 112, and may identify that face as a feature of interest with which the annotation is associated 3D graphics management module 106 may then be operative to determine an apparent depth of that feature of interest by comparing its horizontal position within reference sub-image 112 with its horizontal position within counterpart sub-image 114. More particularly, 3D graphics management module 106 may be operative to determine the apparent depth of the feature of interest based on the horizontal displacement of the feature in counterpart sub-image 114 with respect to reference sub-image 112.

In some embodiments, 3D graphics management module 106 may then be operative to determine a position for the annotation within modified counterpart sub-image 124 that will result in an apparent depth of that annotation within modified 3D image 120 that matches that determined for the feature of interest. In various embodiments, this may comprise applying the same or approximately the same relative horizontal displacement to the annotation in modified counterpart sub-image 124 with respect to that in modified reference sub-image 122 as is exhibited by the feature of interest. In some embodiments, 3D graphics management module 106 may also be operative to perform rectification on modified counterpart sub-image 124 after the insertion of the annotation, to prevent vertical parallax effects in the corresponding region of modified 3D image 120. The embodiments are not limited in this context.

In various embodiments, 3D graphics management module 106 may be operative to utilize visual occlusion to ensure that modified 3D image 120 properly depicts the desired position and apparent depth of an inserted annotation. More particularly, 3D graphics management module 106 may be operative to analyze original 3D image 110 to determine whether any features therein reside at apparent depths and positions that place them in front of the annotation to be added. When it determines that a particular annotation will partially or entirely reside behind one or more features within original 3D image 110, 3D graphics management module 106 may be operative to generate counterpart sub-image modification information 118 indicating that one or more visual occlusion effects are to be applied to part or all of the annotation in modified counterpart sub-image 124. Such visual occlusion effects may comprise, for example, blocking part or all of the annotation or applying transparency effects to the interposed feature such that the annotation is partially visible. The use of such visual occlusion techniques in some embodiments may advantageously preserve the continuity of the apparent depth of the inserted annotation with respect to the apparent depths of neighboring regions in original 3D image 110. The embodiments are not limited in this context.

In various embodiments, once it has determined counterpart sub-image modification information 118, 3D graphics management module 106 may be operative to generate modified counterpart sub-image 124 by modifying counterpart sub-image 114 based on counterpart sub-image modification information 118. In some embodiments, 3D graphics management module 106 may then be operative to generate modified 3D image 120 by combining modified reference sub-image 122 and modified counterpart sub-image 124. In various embodiments, this may comprise generating logic, data, information, and/or instructions to create a logical association between modified reference sub-image 122 and modified counterpart sub-image 124. For example, in an embodiment in which original 3D image 110 and modified 3D image 120 comprise stereoscopic 3D images, 3D graphics management module 106 may be operative to generate a 3D image file comprising modified reference sub-image 122 and modified counterpart sub-image 124 and containing programming logic indicating that modified reference sub-image 122 comprises a left sub-image and modified counterpart sub-image 124 comprises a right sub-image. The embodiments are not limited to this example.

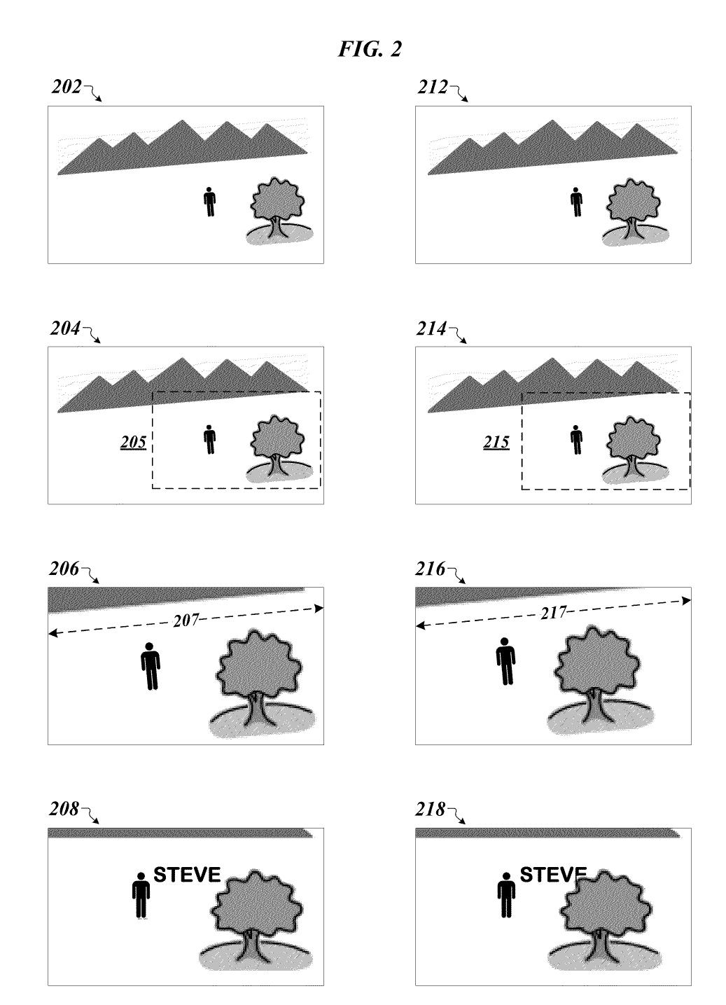

In some embodiments, 3D graphics management module 106 may be operative to receive one or more portions of reference sub-image modification information 116 that indicate multiple desired modifications of original 3D image 110. In various embodiments, for example, 3D graphics management module 106 may receive a series of reference sub-image modification information 116 corresponding to a series of user inputs received by user interface device 150 and/or indicating a series of modifications of various types to be performed on reference sub-image 112. FIG. 2 illustrates an example of such a series of modifications. In FIG. 2, images 202 and 212 illustrate examples of original sub-images comprising a reference sub-image and a counterpart sub-image according to some embodiments. In the example of FIG. 2, image 202 is treated as a reference sub-image, and image 212 is treated as its counterpart sub-image. In image 204, user input has been utilized to draw a cropping window 205 within the reference sub-image. In image 214, a cropping window 215 for the counterpart sub-image has been determined that corresponds to the cropping window 205 in the reference sub-image.

Images 206 and 216 comprise cropped versions of the reference sub-image and the counterpart sub-image, generated according to cropping windows 205 and 215 respectively. In image 206, user input has been utilized to draw a line 207 indicating a desired horizontal axis therein, and thus a desired rotation of image 206. In image 216, a line 217 has been determined that corresponds to the line 207 in image 206. Images 208 and 218 comprise rotated versions of the cropped referee sub-image and the cropped counterpart sub-image, generated according to lines 207 and 217 respectively. In image 208, user input has been utilized to insert an annotation comprising the name “Steve” adjacent to a person in the image. In image 218, this annotation has been inserted in a position corresponding to its position in image 208. Furthermore, visual occlusion has been employed such that a portion of the annotation is blocked by the tee, in order to ensure that the apparent depth of the annotation is consistent with that of the person to which it corresponds. The embodiments are not limited to these examples.

Operations for the above embodiments may be further described with reference to the following figures and accompanying examples. Some of the figures may include a logic flow. Although such figures presented herein may include a particular logic flow, it can be appreciated that the logic flow merely provides an example of low the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

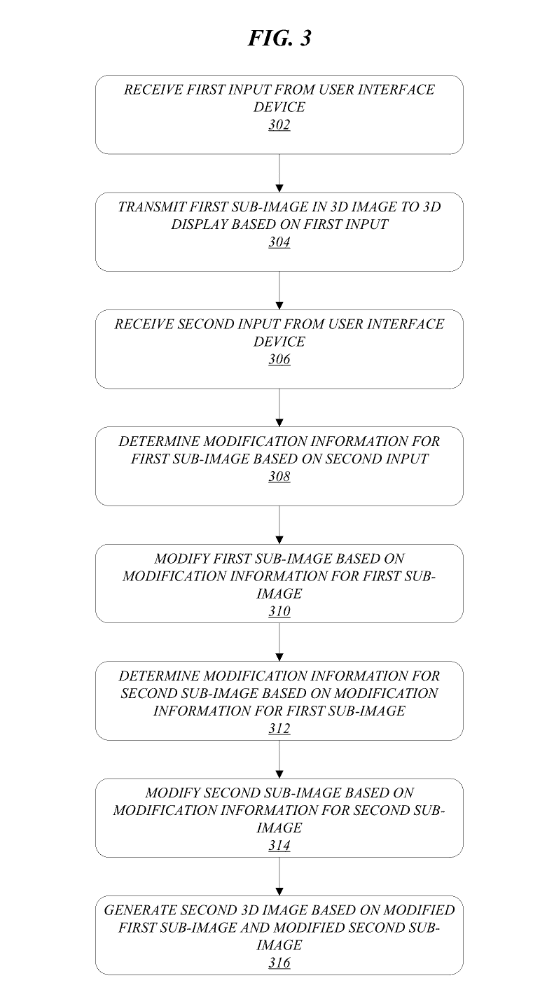

FIG. 3 illustrates one embodiment of a logic flow 300, which may be representative of the operations executed by one or more embodiments described herein. As shown in logic flow 300, a first input may be received at 302. For example, 3D graphics management module 106 of FIG. 1 may receive a first input via user interface device comprising a request to edit original 3D image 110. At 304, a first sub-image within a 3D image may be transmitted to a 3D display based on the first input. For example, 3D graphics management module 106 of FIG. 1 may trans/nit reference sub-image 112 to 3D display 145 based on the request to edit original 3D image 110. At 306, a second input may be received from the user interface device. For example, 3D graphics management module 106 of FIG. 1 may receive a second input indicating desired changes to be made to original 3D image 110 and/or reference sub-image 112. At 308, modification information for the first sub-image may be determined based on the second input. For example, 3D graphics management nodule 106 of FIG. 1 may determine reference sub-image modification information 116 based on the second input.

The logic flow may continue at 310, where the first sub-image may be modified based on the modification information for the first sub-image. For example, 3D graphics management module 106 of FIG. 1 may modify reference sub-image 112 based on reference sub-image modification information 116. At 312, modification information for a second sub-image within the 3D image may be determined based on the modification information for the first sub-image. For example, 3D graphics management module 106 of FIG. 1 may determine counterpart sub-image modification information 118 based on reference sub-image modification information 116. At 314, the second sub-image may be modified based on the modification information for the second sub-image. For example, 3D graphics management module 106 of FIG. 1 may modify counterpart sub-image 114 based on counterpart sub-image modification information 118. At 316, a second 3D image may be generated based on the modified first sub-image and the modified second sub-image. For example, 3D graphics management module 106 of FIG. 1 may generate modified 3D image 120 based on modified reference sub-image 122 and modified counterpart sub-image 124. The embodiments are rot limited to this examples.

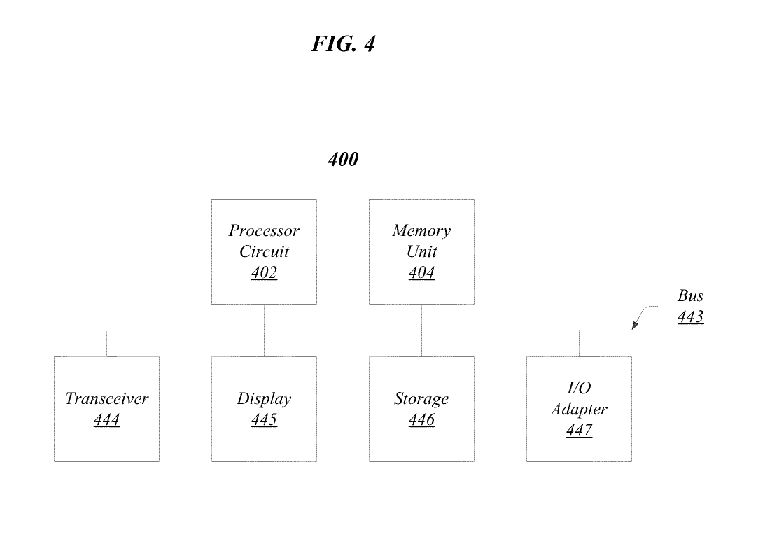

FIG. 4 illustrates one embodiment of a system 400. In various embodiments, system 400 may be representative of a system or architecture suitable for use with one or more embodiments described herein, such as apparatus 100 and/or system 140 of FIG. 1 and/or logic flow 300 of FIG. 3. The embodiments are not limited in this respect.

As shown in FIG. 4, system 400 may include multiple elements. One or more elements may be implemented using one or more circuits, components, registers, processors, software subroutines, modules, or any combination thereof, as desired for a given set of design or performance constraints. Although FIG. 4 shows a limited number of elements in a certain topology by way of example, it can be appreciated that more or less elements in any suitable topology may be used in system 400 as desired for a given implementation. The embodiments are not limited in this context.

In various embodiments, system 400 may include a processor circuit 402. Processor circuit 402 may be implemented using any processor or logic device, and may be the same as or similar to processor circuit 102 of FIG. 1.

In one embodiment, system 400 may include a memory unit 404 to couple to processor circuit 402. Memory unit 404 may be coupled to processor circuit 402 via communications bus 443, or by a dedicated communications bus between processor circuit 402 and memory unit 404, as desired for a given implementation. Memory unit 404 may be implemented using any machine-readable or computer-readable media capable of storing data, including both volatile and non-volatile memory, and may be the same as or similar to memory unit 104 of FIG. 1. In some embodiments, the machine-readable or computer-readable medium may include a non-transitory medium. The embodiments are not limited in this context.

In various embodiments, system 400 may include a transceiver 444. Transceiver 444 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, transceiver 444 may operate in accordance with one or more applicable standards in any version. The embodiments are not limited in this context.

In various embodiments, system 400 may include a display 445. Display 445 may comprise any display device capable of displaying information received from processor circuit 402. In some embodiments, display 445 may comprise a 3D display and may be the same as or similar to 3D display 145 of FIG. 1. The embodiments are not limited in this context.

In various embodiments, system 400 may include storage 446. Storage 446 may be implemented as a non-volatile storage device such as, but not limited to, a magnetic disk drive, optical disk drive, tape chive, an internal storage device, an attached storage device, flash memory, battery backed-up SDRAM (synchronous DRAM, and/or a network accessible storage device. In embodiments, storage 446 may include technology to increase the storage performance enhanced protection for valuable digital media when multiple hard chives are included, for example. Further examples of storage 446 may include a hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of DVD devices, a tape device, a cassette device, or the like. The embodiments are not limited in this context.

In various embodiments, system 400 may include one or more DO adapters 447. Examples of I/O adapters 447 may include Universal Serial Bus (USE) ports/adapters, IEEE 1394 Fire wire ports/adapters, and so forth. The embodiments are not limited in this context.

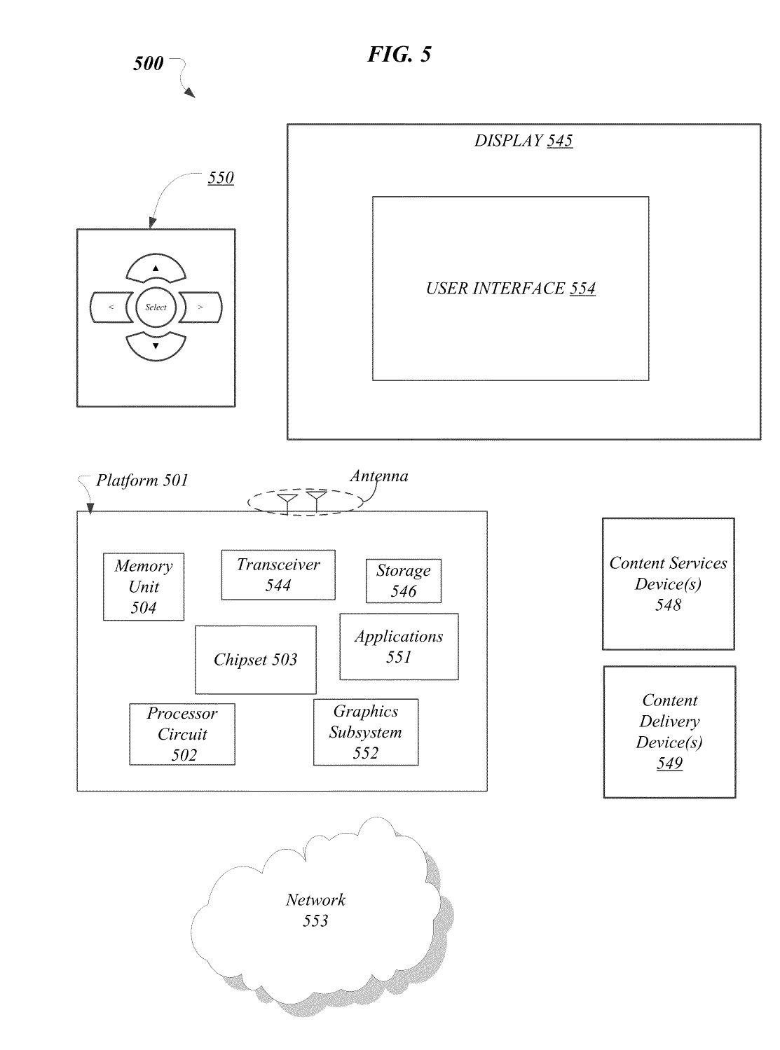

FIG. 5 illustrates an embodiment of a system 500. In various embodiment, system 500 may be representative of a system or architecture suitable for use with one or more embodiments described herein, such as apparatus 100 and/or system 140 of FIG. 1, logic flow 300 of FIG. 3, and/or system 400 of FIG. 4. The embodiments are not limited in this respect.

As shown in FIG. 5, system 500 may include multiple elements. One or more elements may be implemented using one or more circuits, components, registers, processors, software subroutines, modules, or any combination thereof, as desired for a given set of design or performance constraints. Although FIG. 5 shows a limited number of elements in a certain topology by way of example, it can be appreciated that more or less elements in any suitable topology may be used in system 500 as desired for a given implementation. The embodiments are not limited in this context.

In embodiments, system 500 may be a media system although system 500 is not limited to this context. For example, system 500 may be incorporated into a personal computer (PC), laptop computer, ultra-laptop computer, tablet, touch pad, portable computer; handheld computer; palmtop computer; personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 500 includes a platform 501 coupled to a display 545. Platform 501 may receive content from a content device such as content services device(s) 548 or content delivery device(s) 549 or other similar content sources. A navigation controller 550 including one or more navigation features may be used to interact with, for example, platform 501 and/or display 545. Each of these components is described in more detail below.

In embodiments, platform 501 may include any combination of a processor circuit 502, chipset 503, memory unit 504, transceiver 544, storage 546, applications 551, and/or graphics subsystem 552. Chipset 503 may provide intercommunication among processor circuit 502, memory unit 504, transceiver 544, storage 546, applications 551, and/or graphics subsystem 552. For example, chipset 503 may include a storage adapter (not depicted) capable of providing intercommunication with storage 546.

Processor circuit 502 may be implemented using any processor or logic device, and may be the same as or similar to processor circuit 402 in FIG. 4.

Memory unit 504 may be implemented using any machine-readable or computer-readable media capable of storing data, and may be the same as or similar to memory unit 404 in FIG. 4.

Transceiver 544 may include one or more radios capable of transmitting and receiving signals using various suitable wireless communications techniques, and may be the same as or similar to transceiver 444 in FIG. 4.

Display 545 may include any television type monitor or display, and may be the same as or similar to display 445 in FIG. 4.

Storage 546 may be implemented as a non-volatile storage device, and may be the same as or similar to storage 446 in FIG. 4.

Graphics subsystem 552 may perform processing of images such as still or video for display. Graphics subsystem 552 may be a graphics processing unit (GPU) or a visual processing unit (VPU), for example. An analog or digital interface may be used to communicatively couple graphics subsystem 552 and display 545. For example, the interface may be any of a High-Definition Multimedia Interface, Display Port, wireless HDMI, and/or wireless HD compliant techniques. Graphics subsystem 552 could be integrated into processor circuit 502 or chipset 503. Graphics subsystem 552 could be a stand-alone card communicatively coupled to chipset 503.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 548 may be hosted by any national, international and/or independent service and thus accessible to platform 501 via the Internet, for example. Content services device(s) 548 may be coupled to platform 501 and/or to display 545. Platform 501 and/or content services device(s) 548 may be coupled to a network 553 to communicate (e.g., send and/or receive) media information to and from network 553. Content delivery device(s) 549 also may be coupled to platform 501 and/or to display 545.

In embodiments, content services device(s) 548 may include a cable television box, personal computer, network, telephone, Internet enabled devices or appliance capable of delivering digital information and/or content, and any other similar device capable of unidirectionally or bidirectionally communicating content between content providers and platform 501 and/display 545, via network 553 or directly. It will be appreciated that the content may be communicated unidirectionally and/or bidirectionally to and from anyone of the components in system 500 and a content provider via network 553. Examples of content may include any media information including, for example, video, music, medical and gaming information, and so forth.

Content services device(s) 548 receives content such as cable television programming including media information, digital information, and/or other content. Examples of content providers may include any cable or satellite television or radio or Internet content providers. The provided examples are not meant to limit embodiments of the disclosed subject matter.

In embodiments, platform 501 may receive control signals from navigation controller 550 having one or more navigation features. The navigation features of navigation controller 550 may be used to interact with a user interface 554, for example. In embodiments, navigation controller 550 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 550 may be echoed on a display (e.g., display 545) by movements of a pointer, cursor, focus ring, or other visual indicators displayed on the display. For example, under the control of software applications 551, the navigation features located on navigation controller 550 may be mapped to virtual navigation features displayed on user interface 554. In embodiments, navigation controller 550 may not be a separate component but integrated into platform 501 and/or display 545. Embodiments, however, are not limited to the elements or in the context shown or described herein.

In embodiments, drivers (not shown) may include technology to enable users to instantly turn on and off platform 501 like a television with the touch of a button after initial boot-up, when enabled, for example. Program logic may allow platform 501 to stream content to media adaptors or other content services device(s) 548 or content delivery device(s) 549 when the platform is turned “off.” In addition, chip set 503 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or move of the components shown in system 500 may be integrated. For example, platform 501 and content services device(s) 548 may be integrated, or platform 501 and content delivery device(s) 549 may be integrated, or platform. 501, content services device(s) 548, and content delivery device(s) 549 may be integrated, for example. In various embodiments, platform 501 and display 545 may be an integrated unit. Display 545 and content service device(s) 548 may be integrated, or display 545 and content delivery device(s) 549 may be integrated, for example. These examples are not meant to limit the disclosed subject matter.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 501 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to mute media information through a system, or instruct a node to process the media information in a predetermined manner. The embodiments, however, are not limited to the elements or in the context shown or described in FIG. 5.

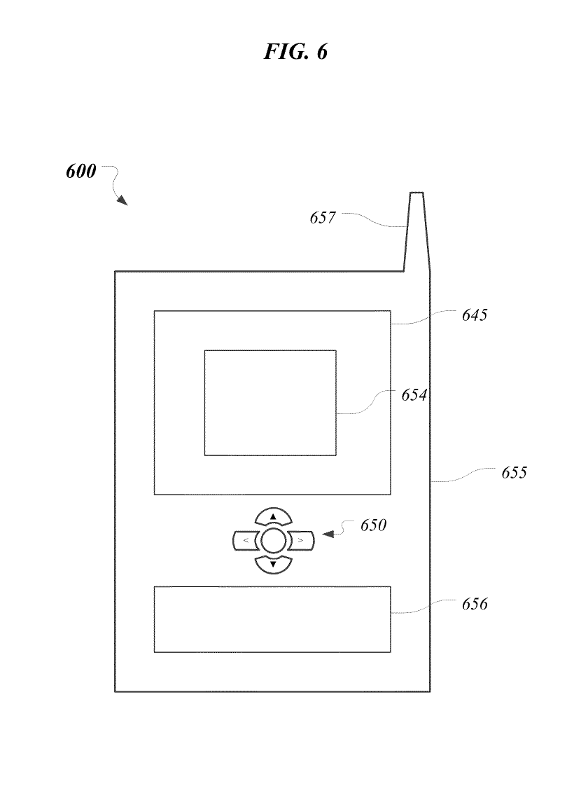

As described above, system 500 may be embodied in varying physical styles or form factors. FIG. 6 illustrates embodiments of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile interne device (MID), messaging device, data communication device, and so forth.

Examples of a mobile computing device also may include computers that are arranged to be morn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not diluted in this context.

As shown in FIG. 6, device 600 may include a display 645, a navigation controller 650, a user interface 654, a housing 655, an I/O device 656, and an antenna 657. Display 645 may include any suitable display unit for displaying information appropriate for a mobile computing device, and may be the same as or similar to display 545 in FIG. 5. Navigation controller 650 may include one or more navigation features which may be used to interact with user interface 654, and may be the same as or similar to navigation controller 550 in FIG. 5. I/O device 656 may include any suitable I/O device for entering information into a mobile computing device. Examples for I/O device 656 may include an alphanumeric keyboard, a numeric keypad, a touch pad, input keys, buttons, switches, rocker switches, microphones, speakers, voice recognition device and software, and so forth. Information also may be entered into device 600 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, lard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various tyres of Digital Versatile Disk (DVD), a tare, a cassette, or the like. The instructions may include any suitable tyre of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments.

Example 1 is at least one machine-readable medium comprising a plurality of instructions for image editing that, in response to being executed on a computing device, cause the computing device to determine modification information for a first sub-image in a three-dimensional (3D) image comprising the first sub-image and a second sub-image, modify the first sub-image based on the modification information for the first sub-image, determine modification information for the second sub-image based on the modification information for the first sub-image, and modify the second sub-image based on the modification information for the second sub-image.

In Example 2, the at least one machine-readable medium of Example 1 can optionally include instructions that, in response to being executed on a computing device, cause the computing device to receive first input from a user interface device, transmit the first sub-image to a 3D display based on the first input, receive second input from the user interface device, and determine the modification information for the first sub-image based on the second input.

In Example 3, the at least one machine-readable medium of anyone of Examples 1-2 can optionally include instructions that, in response to being executed on a computing device, cause the computing device to determine the modification information for the second sub-image using one or more pixel matching techniques to identify one or more corresponding regions of the first sub-image and the second sub-image.

In Example 4, the at least one machine-readable medium of anyone of Examples 1-3 can optionally include instructions that, in response to being executed on a computing device, cause the computing device to determine the modification information for the second sub-image using one or more image rectification techniques to rectify one or more regions of the second sub-image.

In Example 5, the at least one machine-readable medium of anyone of Examples 1-4 can optionally include instructions that, in response to being executed on a computing device, cause the computing device to determine the modification information for the second sub-image using one or more depth estimation techniques to estimate apparent depths of one or more features in the first sub-image.

In Example 6, the modification information for the first sub-image of anyone of Examples 1-5 can optionally indicate at least one of a cropping of the first sub-image, a rotation of the first sub-image, or an annotation of the first sub-image.

In Example 7, the modification information for the first sub-image of anyone of Examples 1-6 can optionally indicate a cropping of the first sub-image.

In Example 8, the modification information for the first sub-image of anyone of Examples 1-7 can optionally indicate a rotation of the first sub-image.

In Example 9, the modification information for the first sub-image of anyone of Examples 1-8 can optionally indicate an annotation of the first sub-image.

In Example 10, the at least one machine-readable medium of Example 9 can optionally include instructions that, in response to being executed on a computing device, cause the computing device to determine that the annotation is to be positioned adjacent to a feature of interest in the first sub-image and insert the annotation in a position adjacent to the feature of interest in the second sub-image.

In Example 11, the at least one machine-readable medium of anyone of Examples 9-10 can optionally include instructions that, in response to being executed on a computing device, cause the computing device to determine the modification information for the second sub-image to partially occlude the annotation in the second sub-image.

In Example 12, the at least one machine-readable medium of any one of Examples 9-11 can optionally include instructions that, in response to being executed on a computing device, cause the computing device to determine the modification information for the second sub-image to apply a transparency effect to a feature blocking a portion of the annotation in the second sub-image.

In Example 13, the at least one machine-readable medium of any one of Examples 1-12 can optionally include instructions that, in response to being executed on a computing device, cause the computing device to generate a second 3D image based on the modified first sub-image and the modified second sub-image.

In Example 14, the first input of any one of Examples 2-13 can optionally comprise a request to edit the 3D image in a 3D graphics application.

In Example 15, the second input of any one of Examples 2-14 can optionally comprise a selection of one or more editing capabilities of the 3D graphics application for performance on the first sub-image.

Example 16 is an image editing apparatus comprising a processor circuit and a three-dimensional (3D) graphics management module for execution on the processor circuit to determine modification information for a first sub-image in a 3D image comprising the first sub-image and a second sub-image, modify the first sub-image based on the modification information for the first sub-image, determine modification information for the second sub-image based on the modification information for the first sub-image, modify the second sub-image based on the modification information for the second sub-image, and generate a second 3D image based on the modified first sub-image and the modified second sub-image.

In Example 17, the 3D graphics management module of Example 16 may optionally be for execution on the processor circuit to: receive first input from a user interface device; transmit the first sub-image to a 3D display based on the first input; receive second input from the user interface device; and determine the modification information for the first sub-image based on the second input.

In Example 18, the 3D graphics management module of anyone of Examples 16-17 may optionally be for execution on the processor circuit to determine the modification information for the second sub-image using one or more pixel matching techniques to identify one or more corresponding regions of the first sub-image and the second sub-image.

In Example 19, the 3D graphics management module of any one of Examples 16-18 may optionally be for execution on the processor circuit to determine the modification information for the second sub-image using one or more image rectification techniques to rectify one or more regions of the second sub-image. In Example 20, the 3D graphics management module of anyone of Examples 16-19 may optionally be for execution on the processor circuit to determine the modification information for the second sub-image using one or more depth estimation techniques to estimate apparent depths of one or more features in the first sub-image.

In Example 21, the modification information for the first sub-image of any one of Examples 16-20 may optionally indicate at least one of a cropping of the first sub-image, a rotation of the first sub-image, or an annotation of the first sub-image.

In Example 22, the modification information for the first sub-image of any one of Examples 16-21 may optionally indicate a cropping of the first sub-image.

In Example 23, the modification information for the first sub-image of any one of Examples 16-22 may optionally indicate a rotation of the first sub-image.

In Example 24, the modification information for the first sub-image of any one of Examples 16-23 may optionally indicate an annotation of the first sub-image.

In Example 25, the 3D graphics management module of Example 24 may optionally be for execution on the processor circuit to determine that the annotation is to be positioned adjacent to a feature of interest in the first sub-image and insert the annotation in a position adjacent to the feature of interest in the second sub-image.

In Example 26, the 3D graphics management module of any one of Examples 24-25 may optionally be for execution on the processor circuit to determine the modification information for the second sub-image to partially occlude the annotation in the second sub-image.

In Example 27, the 3D graphics management module of any one of Examples 24-26 may optionally be for execution on the processor circuit to determine the modification information for the second sub-image to apply a transparency effect to a feature blocking a portion of the annotation in the second sub-image.

In Example 28, the 3D graphics management module of any one of Examples 16-27 may optionally be for execution on the processor circuit to generate a second 3D image based on the modified first sub-image and the modified second sub-image.

In Example 29, the first input of any one of Examples 17-28 may optionally comprise a request to edit the 3D image in a 3D graphics application.

In Example 30, the second input of anyone of Examples 17-29 may optionally comprise a selection of one or more editing capabilities of the 3D graphics application for performance on the first sub-image.

Example 31 is an image editing method, comprising: determining modification information for a first sub-image in a three-dimensional (3D) image comprising the first sub-image and a second sub-image; modifying the first sub-image based on the modification information for the first sub-image; determining modification information for the second sub-image based on the modification information for the first sub-image; and modifying the second sub-image based on the modification information for the second sub-image.

In Example 32, the method of Example 31 may optionally comprise: receiving first input from a user interface device; transmitting the first sub-image to a 3D display based on the first input; receiving second input from the user interface device; and determining the modification information for the fast sub-image based on the second input.

In Example 33, the method of anyone of Examples 31-32 may optionally comprise determining the modification information for the second sub-image using one or more pixel matching techniques to identify one or more corresponding regions of the first sub-image and the second sub-image.

In Example 34, the method of any one of Examples 31-33 may optionally comprise determining the modification information for the second sub-image using one or more image rectification techniques to rectify one or more regions of the second sub-image.

In Example 35, the method of anyone of Examples 31-34 may optionally comprise determining the modification information for the second sub-image using one or more depth estimation techniques to estimate apparent depths of one or more features in the first sub-image.

In Example 36, the modification information for the first sub-image of any one of Examples 31-35 can optionally indicate at least one of a cropping of the first sub-image, a rotation of the first sub-image, or an annotation of the first sub-image.

In Example 37, the modification information for the first sub-image of any one of Examples 31-36 can optionally indicate a cropping of the first sub-image.

In Example 38, the modification information for the first sub-image of any one of Examples 31-37 can optionally indicate a rotation of the first sub-image.

In Example 39, the modification information for the first sub-image of any one of Examples 31-38 can optionally indicate an annotation of the first sub-image.

In Example 40, the method of Example 39 may optionally comprise determining that the annotation is to be positioned adjacent to a feature of interest in the first sub-image; and inserting the annotation in a position adjacent to the feature of interest in the second sub-image.

In Example 41, the method of anyone of Examples 39-40 may optionally comprise determining the modification information for the second sub-image to partially occlude the annotation in the second sub-image.

In Example 42, the method of anyone of Examples 39-41 may optionally comprise determining the modification information for the second sub-image to apply a transparency effect to a feature blocking a portion of the annotation in the second sub-image.

In Example 43, the method of anyone of Examples 31-42 may optionally comprise gene rating a second 3D image based on the modified first sub-image and the modified sec and sub-image.

In Example 44, the first input of any one of Examples 32-43 can optionally comprise are quest to edit the 3D image in a 3D graphics application.

In Example 45, the second input of any one of Examples 32-44 can optionally comprise a selection of one or more editing capabilities of the 3D graphics application for performance on the first sub-image.

In Example 46, at least one machine-readable medium may comprise a plurality of instructions that, in response to being executed on a computing device, cause the computing device to perform a method according to anyone of Examples 31 to 45.

In Example 47, an apparatus may comprise means for performing a method according to any one of Examples 31 to 45.

In Example 43, a communications device may be arranged to perform a method according to anyone of Examples 31 to 45.

Example 49 is an image editing system comprising a processor circuit, a transceiver, and a three-dimensional (3D) graphics management module for execution on the processor circuit to determine modification information for a first sub-image in a 3D image comprising the first sub-image and a second sub-image, modify the first sub-image based on the modification information for the first sub-image, determine modification information for the second sub-image based on the modification information for the first sub-image, modify the second sub-image based on the modification information for the second sub-image, and generate a second 3 D image based on the modified first sub-image and the modified second sub-image.

In Example 50, the 3D graphics management module of Example 49 may optionally be for execution on the processor circuit to: receive first input from a user interface device; transmit the first sub-image to a 3D display based on the first input; receive second input from the user interface device; and determine the modification information for the first sub-image based on the se coed input.

In Example 51, the 3D graphics management module of any one of Examples 49-50 may optionally be for execution on the processor circuit to determine the modification information for the second sub-image using one or more pixel matching techniques to identify one or more corresponding regions of the first sub-image and the second sub-image.

In Example 52, the 3D graphics management module of any one of Examples 49-51 may optionally be for execution on the processor circuit to determine the modification information for the second sub-image using one or more image rectification techniques to rectify one or more regions of the second sub-image.

In Example 53, the 3D graphics management module of any one of Examples 49-52 may optionally be for execution on the processor circuit to determine the modification information for the second sub-image using one or more depth estimation techniques to estimate apparent depths of one or more features in the first sub-image.

In Example 54, the modification information for the first sub-image of any one of Examples 49-53 may optionally indicate at least one of a cropping of the first sub-image, a rotation of the first sub-image, or an annotation of the first sub-image.

In Example 55, the modification information for the first sub-image of any one of Examples 49-54 may optionally indicate a cropping of the first sub-image.

In Example 56, the modification information for the first sub-image of any one of Examples 49-55 may optionally indicate a rotation of the first sub-image.

In Example 57, the modification information for the first sub-image of any one of Examples 49-56 may optionally indicate an annotation of the first sub-image.

In Example 58, the 3D graphics management module of Example 57 may optionally be for execution on the processor circuit to determine that the annotation is to be positioned adjacent to a feature of interest in the first sub-image and insert the annotation in a position adjacent to the feature of interest in the second sub-image.

In Example 59, the 3D graphics management module of any one of Examples 57-58 may optionally be for execution on the processor circuit to determine the modification information for the second sub-image to partially occlude the annotation in the second sub-image.

In Example 60, the 3D graphics management module of any one of Examples 57-59 may optionally be for execution on the processor circuit to determine the modification information for the second sub-image to apply a transparency effect to a feature blocking a portion of the annotation in the second sub-image.

In Example 61, the 3D graphics management module of any one of Examples 49-60 may optionally be for execution on the processor circuit to generate a second 3D image based on the modified first sub-image and the modified second sub-image.

In Example 62, the first input of anyone of Examples 50-61 may optionally comprise are quest to edit the 3D image in a 3D graphics application.

In Example 63, the second input of anyone of Examples 50-62 may optionally comprise a selection of one or more editing capabilities of the 3D graphics application for performance on the first sub-image.

Example 64 is an image editing apparatus, comprising: means for determining modification information for a first sub-image in a three-dimensional (3D) image comprising the first sub-image and a second sub-image; means for modifying the first sub-image based on the modification information for the first sub-image; means for determining modification information for the second sub-image based on the modification information for the first sub-image; and means for modifying the second sub-image based on the modification information for the second sub-image.

In Example 65, the apparatus of Example 64 may optionally comprise: means for receiving first input from a user interface device; means for transmitting the first sub-image to a 3D display based on the first input; means for receiving second input from the user interface device; and means for determining the modification information for the first sub-image based on the second input.

In Example 66, the apparatus of anyone of Examples 6465 may optionally comprise means for determining the modification information for the second sub-image using one or more pixel matching techniques to identify one or more corresponding regions of the first sub-image and the second sub-image.

In Example 67, the apparatus of any one of Examples 6466 may optionally comprise means for determining the modification information for the second sub-image using one or more image rectification techniques to rectify one or more regions of the second sub-image.

In Example 68, the apparatus of anyone of Examples 64-67 may optionally comprise means for determining the modification information for the second sub-image using one or more depth estimation techniques to estimate apparent depths of one or more features in the first sub-image.

In Example 69, the modification information for the first sub-image of any one of Examples 64-68 may optionally indicate at least one of a cropping of the first sub-image, a rotation of the first sub-image, or an annotation of the first sub-image.

In Example 70, the modification information for the first sub-image of any one of Examples 64-69 may optionally indicate a cropping of the first sub-image.

In Example 71, the modification information for the first sub-image of any one of Examples 64-70 may optionally indicate a rotation of the first sub-image.

In Example 72, the modification information for the first sub-image of any one of Examples 64-71 may optionally indicate an annotation of the first sub-image.

In Example 73, the apparatus of Example 72 may optionally comprise: means for determining that the annotation is to be positioned adjacent to a feature of interest in the first sub-image; and means for inserting the annotation in a position adjacent to the feature of interest in the second sub-image.

In Example 74, the apparatus of anyone of Examples 72-73 may optionally comprise means for determining the modification information for the second sub-image to partially occlude the annotation in the second sub-image.

In Example 75, the apparatus of anyone of Examples 72-74 may optionally comprise means for determining the modification information for the second sub-image to apply a transparency effect to a feature blocking a portion of the annotation in the second sub-image.

In Example 76, the apparatus of anyone of Examples 64-75 may optionally comprise means for generating a second 3D image based on the modified first sub-image and the modified second sub-image.

In Example 77. The apparatus of any one of Examples 65-76, the first input comprising a request to edit the 3D image in a 3D graphics application.

In Example 78. The apparatus of any one of Examples 65-77, the second input comprising a selection of one or more editing capabilities of the 3D graphics application for performance on the first sub-image.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and rot a restrictive one. Combinations of the above embodiments, and other embodiments not specifically described here in will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1.-25. (canceled)

26. At least one machine-readable medium comprising a plurality of instructions that, in response to being executed on a computing device, cause the computing device to:
determine modification information for a first sub-image in a three-dimensional (3D) image comprising the first sub-image and a second sub-image;
modify the first sub-image based on the modification information for the first sub-image;
determine modification information for the second sub-image based on the modification information for the first sub-image; and
modify the second sub-image based on the modification information for the second sub-image.

27. The at least one machine-readable medium of claim 26, comprising instructions that, in response to being executed on a computing device, cause the computing device to:
receive first input from a user interface device;
transmit the first sub-image to a 3D display based on the first input;
receive second input from the user interface device; and
determine the modification information for the first sub-image based on the second input.

28. The at least one machine-readable medium of claim 26, comprising instructions that, in response to being executed on a computing device, cause the computing device to determine the modification information for the second sub-image using one or more pixel matching techniques to identify one or more corresponding regions of the first sub-image and the second sub-image.

29. The at least one machine-readable medium of claim 26, comprising instructions that, in response to being executed on a computing device, cause the computing device to determine the modification information for the second sub-image using one or more image rectification techniques to rectify one or more regions of the second sub-image.

30. The at least one machine-readable medium of claim 26, comprising instructions that, in response to being executed on a computing device, cause the computing device to determine the modification information for the second sub-image using one or more depth estimation techniques to estimate apparent depths of one or more features in the first sub-image.

31. The at least one machine-readable medium of claim 26, the modification information for the first sub-image indicating at least one of a cropping of the first sub-image, a rotation of the first sub-image, or an annotation of the first sub-image.

32. The at least one machine-readable medium of claim 26, comprising instructions that, in response to being executed on a computing device, cause the computing device to generate a second 3D image based on the modified first sub-image and the modified second sub-image.

33. An apparatus, comprising:
a processor circuit; and
a three-dimensional (3D) graphics management module for execution on the processor circuit to:
determine modification information for a first sub-image in a 3D image comprising the first sub-image and a second sub-image;
modify the first sub-image based on the modification information for the first sub-image;
determine modification information for the second sub-image based on the modification information for the first sub-image;
modify the second sub-image based on the modification information for the second sub-image; and
generate a second 3D image based on the modified first sub-image and the modified second sub-image.

34. The apparatus of claim 33, the 3D graphics management module for execution on the processor circuit to:
receive first input from a user interface device;
transmit the first sub-image to a 3D display based on the first input;
receive second input from the user interface device; and
determine the modification information for the first sub-image based on the second input.

35. The apparatus of claim 33, the 3D graphics management module for execution on the processor circuit to determine the modification information for the second sub-image using one or more pixel matching techniques to identify one or more corresponding regions of the first sub-image and the second sub-image.

36. The apparatus of claim 33, the 3D graphics management module for execution on the processor circuit to determine the modification information for the second sub-image using one or more image rectification techniques to rectify one or more regions of the second sub-image.

37. The apparatus of claim 33, the 3D graphics management module for execution on the processor circuit to determine the modification information for the second sub-image using one or more depth estimation techniques to estimate apparent depths of one or more features in the first sub-image.

38. The apparatus of claim 33, the modification information for the first sub-image indicating at least one of a cropping of the first sub-image, a rotation of the first sub-image, or an annotation of the first sub-image.

39. A method, comprising:
transmitting a first sub-image in a three-dimensional (3D) image comprising the first sub-image and a second sub-image to a 3D display
receiving input from a user interface device;
determining modification information for the first sub-image based on the received input;
modifying the first sub-image based on the modification information for the first sub-image;
determining modification information for the second sub-image based on the modification information for the first sub-image; and
modifying the second sub-image based on the modification information for the second sub-image.

40. The method of claim 39, comprising determining the modification information for the second sub-image using one or more pixel matching techniques to identify one or more corresponding regions of the first sub-image and the second sub-image

41. The method of claim 39, comprising determining the modification information for the second sub-image using one or more image rectification techniques to rectify one or more regions of the second sub-image

42. The method of claim 39, comprising determining the modification information for the second sub-image using one or more depth estimation techniques to estimate apparent depths of one or more features in the first sub-image

43. The method of claim 39, the received input indicating at least one of a cropping of the first sub-image, a rotation of the first sub-image, or an annotation of the first sub-image.

44. The method of claim 39, comprising generating a second 3D image based on the modified first sub-image and the modified second sub-image.

45. A system, comprising:
a processor circuit;
a transceiver; and
a 3D graphics management module for execution on the processor circuit to:
determine modification information for a first sub-image in a three-dimensional (3D) image comprising the first sub-image and a second sub-image;
modify the first sub-image based on the modification information for the first sub-image;
determine modification information for the second sub-image based on the modification information for the first sub-image; and
modify the second sub-image based on the modification information for the second sub-image.

46. The system of claim 45, the 3D graphics management module for execution on the processor circuit to:
receive first input from a user interface device;
transmit the first sub-image to a 3D display based on the first input;
receive second input from the user interface device; and
determine the modification information for the first sub-image based on the second input.

47. The system of claim 45, the 3D graphics management module for execution on the processor circuit to determine the modification information for the second sub-image using one or more pixel matching techniques to identify one or more corresponding regions of the first sub-image and the second sub-image.

48. The system of claim 45, the 3D graphics management module for execution on the processor circuit to determine the modification information for the second sub-image using one or more image rectification techniques to rectify one or more regions of the second sub-image.

49. The system of claim 45, the 3D graphics management module for execution on the processor circuit to determine the modification information for the second sub-image using one or more depth estimation techniques to estimate apparent depths of one or more features in the first sub-image.

50. The system of claim 45, the modification information for the first sub-image indicating at least one of a cropping of the first sub-image, a rotation of the first sub-image, or an annotation of the first sub-image.
